(19) United States
(12) Patent Application Publication
(10) Pub. No.: US 2014/0289727 A1
(43) Pub. Date: Sep. 25, 2014

(54) COMPUTING DEVICE AND METHOD FOR EXPANDING HARDWARE FUNCTIONS OF THE COMPUTING DEVICE

(71) Applicant: HON HAI PRECISION INDUSTRY CO., LTD., New Taipei (TW)

(72) Inventors: CHUNG-I LEE, New Taipei (TW); CHIU-HUA LU, New Taipei (TW); LEE-FAN CHANG, New Taipei (TW); YU-CHUN LIN, New Taipei (TW); CHIEN-CHIH LIN, New Taipei (TW); TSUNG-HSIN YEN, New Taipei (TW)

(73) Assignee: HON HAI PRECISION INDUSTRY CO., LTD., New Taipei (TW)

(21) Appl. No.: 14/038,809

(22) Filed: Sep. 27, 2013

(30) Foreign Application Priority Data
Mar. 21, 2013 (TW) 102109957

(51) Int. Cl. G06F 9/455

(52) U.S. Cl. CPC G06F 9/455
USPC 718/1

(57) ABSTRACT

In a method for expanding hardware functions of a computing device, a virtual component is created in the computing device. The virtual component corresponds to a physical component desired by the computing device. The computing device detects an electronic device equipped with the physical component. A communication channel between the virtual component and the electronic device is established. Via the communication channel, a data processing request and data requested to be processed by the computing device are transferred from the computing device to the electronic device. The computing device receives a processing result of the data from the electronic device, and stores the processing result in a storage system.

### BACKGROUND

1. Technical Field

Embodiments of the present disclosure relate to virtualization technology, and particularly to a computing device and a method for expanding hardware functions of the computing device.

2. Description of Related Art

Limited by a size and/or a cost of a computing device (e.g., a mobile phone), some physical components (e.g., three-dimensional accelerated graphics cards) might not be installed in the computing device. Therefore, the computing device cannot provide some functions to users.

### BRIEF DESCRIPTION OF THE DRAWINGS

FIG. 1 is one embodiment of an application of a computing device including a hardware function expanding system.

FIG. 2 is a block diagram of one embodiment of function modules of the hardware function expanding system in FIG. 1.

FIG. 3 is a flowchart of one embodiment of a method for expanding hardware functions of the computing device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in hardware or firmware, or to a collection of computer program instructions, written in a programming language, such as, JAVA, C, or assembly. One or more computer program instructions in the modules may be embedded in firmware, such as in an erasable programmable read only memory (EPROM). The modules described herein may be implemented as either computer program and/or hardware modules and may be stored in any type of non-transitory computer-readable medium or other storage device. Some non-limiting examples of non-transitory computer-readable media include CDs, DVDs, BLU-RAY, flash memory, and hard drive drives.

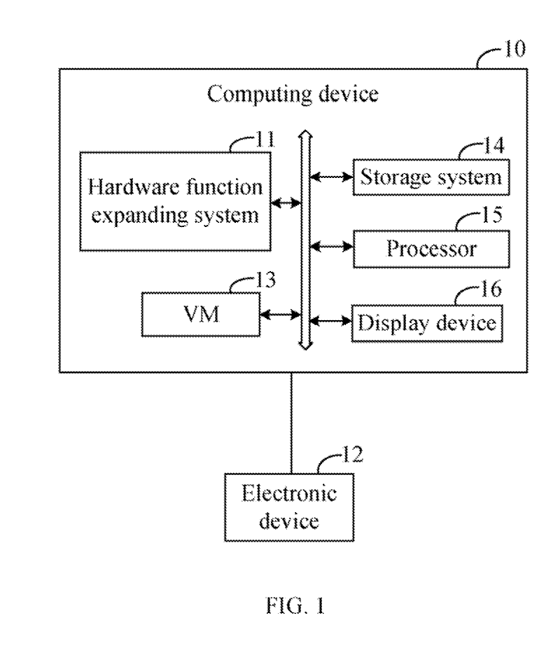

FIG. 1 is one embodiment of an application of a computing device 10 including a hardware function expanding system 11. The computing device 10 is connected to one or more electronic devices 12 (e.g., servers, only one shown). One or more virtual machines (VMs) 13 (only one shown) are installed in the computing device 10. The hardware function expanding system 11 expands hardware functions of the computing device 10 by making use of physical components installed in the electronic device 12 to process data. The computing device 10 may be a mobile device, such as a mobile phone.

In this embodiment, the computing device 10 further includes a storage system 14, at least one processor 15, and a display device 16. The storage system 14 can be a dedicated memory, such as an EPROM, a hard disk drive (HDD), or flash memory. In some embodiments, the storage system 14 can be an external storage device, such as an external hard drive, a storage card, or a data storage medium.

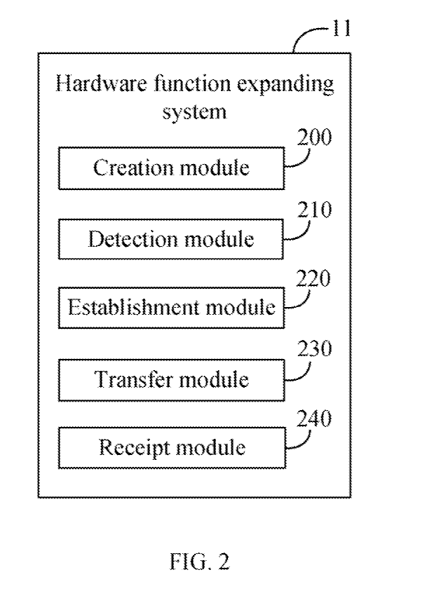

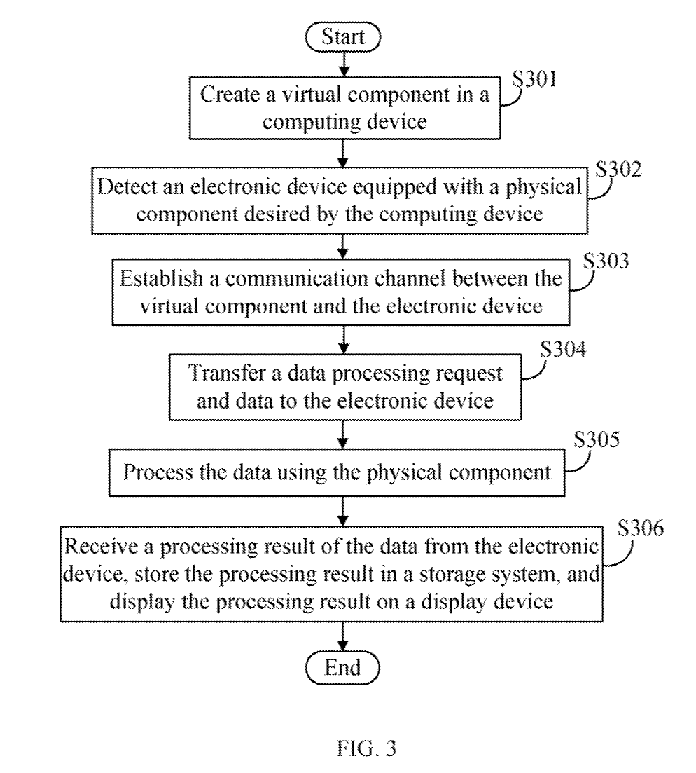

FIG. 2 is a block diagram of one embodiment of function modules of the hardware function expanding system 11 in FIG. 1. The hardware function expanding system 11 includes a creation module 200, a detection module 210, an establishment module 220, a transfer module 230, and a receipt module 240. The modules 200-240 may comprise computerized code in the form of one or more programs that are stored in the storage system 14. The computerized code includes instructions that are executed by the at least one processor 15, to provide the aforementioned functions of the hardware function expanding system 11. A detailed description of the functions of the modules 200-240 is given in reference to FIG. 3.

FIG. 3 is a flowchart of one embodiment of a method for expanding hardware functions of the computing device 10 of FIG. 1. Depending on the embodiment, additional steps may be added, others removed, and the ordering of the steps may be changed.

In step S301, the creation module 200 creates a virtual component in the computing device 10. The virtual component corresponds to a physical component desired by the computing device 10. For example, the computing device 10 is desired to provide a function of accelerated rendering of three-dimensional (3D) images while the computing device 10 is not equipped with any physical 3D accelerated graphics card. In this case, the creation module 200 creates a virtual 3D accelerated graphics card in the computing device 10. In one embodiment, the virtual component is created in a VM 13.

In step S302, the detection module 210 detects an electronic device 12 equipped with the physical component desired by the computing device 10. For example, the detection 210 detects an electronic device 12 equipped with the 3D accelerated graphics card.

In step S303, the establishment module 220 establishes a communication channel between the virtual component and the electronic device 12. In this embodiment, the establishment module 220 creates a first remote procedure call (RPC) interface in the virtual component. The electronic device 12 creates a second RPC interface in the electronic device 12. Therefore, the communication channel between the virtual component and the electronic device 12 is established.

In step S304, the transfer module 230 transfers a data processing request and data requested to be processed by the computing device 10 to the electronic device 12 via the communication channel. In this embodiment, the request module 230 transfers the data processing request and the data to the electronic device 12 via the first RPC interface created in the virtual component and the second RPC interface created in the electronic device 12.

In step S305, the electronic device 12 receives the data processing request and the data from the computing device 10. In response to the data processing request, the electronic device 12 processes the data using the physical component of the electronic device 12. For example, the electronic device 12 uses the 3D accelerated graphics card installed in the electronic device 12 to process the data and obtains 3D images.

In step S306, the receipt module 240 receives a processing result of the data from the electronic device 12, stores the processing result in the storage system 14, and displays the processing result on the display device 16. For example, the receipt module 240 receives the 3D images from the electronic device 12, stores the 3D images in the storage system 14, and displays the 3D images on the display device 16.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for expanding hardware functions of a computing device being executed by a processor of the computing device, the method comprising:
creating a virtual component in the computing device, wherein the virtual component corresponds to a physical component desired by the computing device;
detecting an electronic device equipped with the physical component;
establishing a communication channel between the virtual component and the electronic device;
transferring a data processing request and data requested to be processed by the computing device to the electronic device via the communication channel; and
receiving a processing result of the data from the electronic device, and storing the processing result in a storage system.

2. The method of claim 1, wherein the virtual component is created in a virtual machine installed in the computing device.

3. The method of claim 1, wherein the communication channel between the virtual component and the electronic device is established by creating a first remote procedure call (RPC) interface in the virtual component and creating a second RPC interface in the electronic device.

4. The method of claim 1, further comprising:
displaying the processing result of the data on a display device.

5. A computing device, comprising:
at least one processor; and
a storage system storing a plurality of instructions, when executed by the at least one processor, causing the at least one processor to perform operations comprising:
creating a virtual component in the computing device, wherein the virtual component corresponds to a physical component desired by the computing device;
detecting an electronic device equipped with the physical component;
establishing a communication channel between the virtual component and the electronic device;
transferring a data processing request and data requested to be processed by the computing device to the electronic device via the communication channel; and
receiving a processing result of the data from the electronic device, and storing the processing result in a storage system.

6. The computing device of claim 5, wherein the virtual component is created in a virtual machine installed in the computing device.

7. The computing device of claim 5, wherein the communication channel between the virtual component and the electronic device is established by creating a first remote procedure call (RPC) interface in the virtual component and creating a second RPC interface in the electronic device.

8. The computing device of claim 5, wherein the instructions further cause the at least one processor to perform operations comprising:
displaying the processing result of the data on a display device.

9. A non-transitory storage medium storing a set of instructions, the set of instructions capable of being executed by a processor of a computing device to implement a method for expanding hardware functions of the computing device, the method comprising:
creating a virtual component in the computing device, wherein the virtual component corresponds to a physical component desired by the computing device;
detecting an electronic device equipped with the physical component;
establishing a communication channel between the virtual component and the electronic device;
transferring a data processing request and data requested to be processed by the computing device to the electronic device via the communication channel; and
receiving a processing result of the data from the electronic device, and storing the processing result in a storage system.

10. The non-transitory storage medium of claim 9, wherein the virtual component is created in a virtual machine installed in the computing device.

11. The non-transitory storage medium of claim 9, wherein the communication channel between the virtual component and the electronic device is established by creating a first remote procedure call (RPC) interface in the virtual component and creating a second RPC interface in the electronic device.

12. The non-transitory storage medium of claim 9, wherein the method further comprising:
displaying the processing result of the data on a display device.
